(19) United States
(12) Patent Application Publication
(10) Pub. No.: US 2009/0066040 A1
(43) Pub. Date: Mar. 12, 2009

(54) Saw gripping device for cutting machine

(75) Inventors: Cheng-I Teng, Taichung County (TW); Jin-Hung Chen, Taoyuan County (TW)

Correspondence Address: BACON & THOMAS, PLLC, 625 SLATERS LANE, FOURTH FLOOR, ALEXANDRIA, VA, 22314-1176, US

(73) Assignee: MOBILETRON ELECTRONICS CO., LTD., TAICHUNG HSIEN (TW)

(21) Appl. No.: 11/979,395

(22) Filed: Nov. 2, 2007

(30) Foreign Application Priority Data
Sep. 11, 2007 (TW) 96133945

(51) Int. Cl. B23D 51/08

(52) U.S. Cl. 279/81

(57) ABSTRACT

A saw gripping device for a cutting machine includes a main body having a lug formed on an external sidewall thereof; a control member slidably sleeved onto the main body and having an inclined annular convexity formed on an internal sidewall thereof and a stopping portion extending slantwise from an end thereof toward the other end thereof; and a spring having two ends fixed to the main body and the control member respectively to be located therebetween for keeping the inclined annular convexity lying against a stopper slidably inserted into the main body and to keep the stopping portion lying against the lug. In light of this, the control member can be prevented from incorrect action during the reciprocating motion of the cutting machine. In addition, where the stopping portion lies against the lug is variable subject to the thickness of the cutting saw.

### BACKGROUND OF THE INVENTION

1. Field of the Invention

The present invention relates generally to cutting machines, and more particularly, to a saw gripping device for a cutting machine.

2. Description of the Related Art

A common cutting machine includes an output shaft, which can be moved in linear reciprocating manner. The output shaft has a free end connected with a saw gripping device provided for holding a cutting saw. The cutting saw can be synchronically driven by the cutting saw for linear reciprocating motion to cut a workpiece.

Referring to FIGS. 1 and 2, a conventional saw gripping device is composed of a main part 1, two steel balls 2, a control member 3, and a spring 4. The main part 1 is a column, having a first end 1a located an end thereof for connection with an output shaft 5 of a cutting machine, and a second end 1b located at an opposite end thereof. The main part 1 includes a receiving tunnel 1c and two through holes 1d. The receiving tunnel 1c is parallel to an imaginary center axis of the main part 1, defining an opening at an end surface of the second end 1b of the main part 1. The two through holes 1d are located at two opposite sides of the receiving tunnel 1c respectively, running through the sidewall of the receiving tunnel 1c and the sidewall of the main part 1 respectively. The two steel balls 2 are located in the two through holes 1d respectively and each have two opposite parts exposed outside two openings of the through hole 1d respectively. The control member 3 is a tube-shaped and sleeved onto the main part 1, having an inclined annular convexity 3a formed on the internal periphery thereof and facing the exposed parts of the steel balls 2. The spring 4 is mounted between the main part 1 and the control member 3 for pushing the control member 3 and keeping it located at where the inclined annular convexity 3a contacts against the two steel balls 2.

In light of the above, axially push the control member 3 to counterwork the resilience of the spring 4 for movement to let the inclined annular convexity 3a depart from the two steel balls 2, so that a connection end of a cutting saw 6 can be inserted into the receiving tunnel 1c of the main part 1. After that, release the control member 3 to allow the spring 3 to again push the control member 3 till the inclined annular convexity 3a contacts against the two steel balls 2 and the steel balls 2 lie against a positioning portion 6a of the cutting saw 6, as shown in FIG. 1. Therefore, the cutting saw 6 is locked on the saw gripping device. On the contrary, again axially push the control member 3 to counterwork the resilience of the spring 4 for movement to let the inclined annular convexity 3a depart from the steel balls 2, such that the cutting saw 6 can be removed from the saw gripping device.

However, such conventional saw gripping device has some drawbacks. When the gripping device is driven by the cutting machine for rapid reciprocating motion together with the cutting saw 6, the control member 3 is subject to movement resulted from an impulse generated in such a way that an inertial force generated by the reciprocating motion counterworks the resilience of the spring 4, such that the inclined annular convexity 3a immediately departs from the two steel balls 2 and then the cutting saw 6 disengages from the gripping device. Under the circumstances, it is very dangerous because the cutting saw 6 probably bounces to hurt the operator around the cutting machine after disengaging from the gripping device. Besides, it may happen during the operation of the cutting machine or while the control member impinges a workpiece or other objects.

As for the aforesaid drawback, an improved saw gripping device was developed, utilizing a positioning recess of a control member and a lug of a main part to avoid the control member from incorrect action. Although this improved saw gripping device improves the aforesaid drawback, the cutting saw is held bilaterally by two steel balls, such that it is inapplicable to cutting saws having different thickness.

### SUMMARY OF THE INVENTION

The primary objective of the present invention is to provide a saw gripping device for a cutting machine, which can prevent a cutting saw held thereby from accidental disengagement during reciprocating motion of the cutting machine.

The secondary objective of the present invention is to provide a saw gripping device for a cutting machine, which is applicable to cutting saws having different thickness.

The foregoing objectives of the present invention are attained by the saw gripping device composed of a column-shaped main body, a tube-shaped control member, and a spring. The spring has two ends fixed to the main body and the control member respectively to be located therebetween, for applying axial impulse and torsion to the main body and the control member. The control member is sleeved onto the main body, having an inclined annular convexity formed on an internal sidewall thereof and a stopping portion extending slantwise from an end thereof toward the other end thereof. The main body includes a lug formed on an external sidewall thereof. The axial impulse and torsion applied to the control member can keep the inclined annular convexity lying against a stopper slidably inserted into the main body and keep the stopping portion lying against the lug.

In such a way that the stopping portion under the torsion of the spring lies against the lug, it prevents the control member from incorrect action incurred by an inertial force generated during the reciprocating motion of the cutting machine or by unexpected impact of an object. Where the stopping portion lies against the lug is variable subject to the thickness of the cutting saw and can still prevent the control member from incorrect action.

### BRIEF DESCRIPTION OF THE DRAWINGS

FIG. 1 is a sectional view of the conventional device, showing that the cutting saw is held tight.

FIG. 2 is another sectional view of the conventional device, showing that the cutting saw is not held tight.

FIG. 3 is an exploded view of a preferred embodiment of the present invention.

FIG. 4 is a schematic view of assembly process of a part of the preferred embodiment of the present invention.

FIG. 5 is another schematic view of assembly process of a part of the preferred embodiment of the present invention.

FIG. 6 is a perspective view of the preferred embodiment of the present invention, showing that the cutting saw is not held tight.

FIG. 7 similar to FIG. 6 is a side view of a part of the preferred embodiment of the present invention.

FIG. 8 similar to FIG. 6 is a sectional view of a part of the preferred embodiment of the present invention.

FIG. 9 is a perspective view of the preferred embodiment of the present invention, showing that the cutting saw is held tight.

FIG. 10 similar to FIG. 9 is a side view of a part of the preferred embodiment of the present invention.

FIG. 11 similar to FIG. 9 is a sectional view of a part of the preferred embodiment of the present invention.

FIG. 12 is a side view of a part of the preferred embodiment of the present invention holding a relatively thinner cutting saw.

FIG. 13 is a side view of a part of the preferred embodiment of the present invention holding a relatively thicker cutting saw.

FIG. 14 is a perspective view of the preferred embodiment of the present invention, showing that the cutting saw is held at different position.

FIG. 15 similar to FIG. 14 is a sectional view of the preferred embodiment of the present invention.

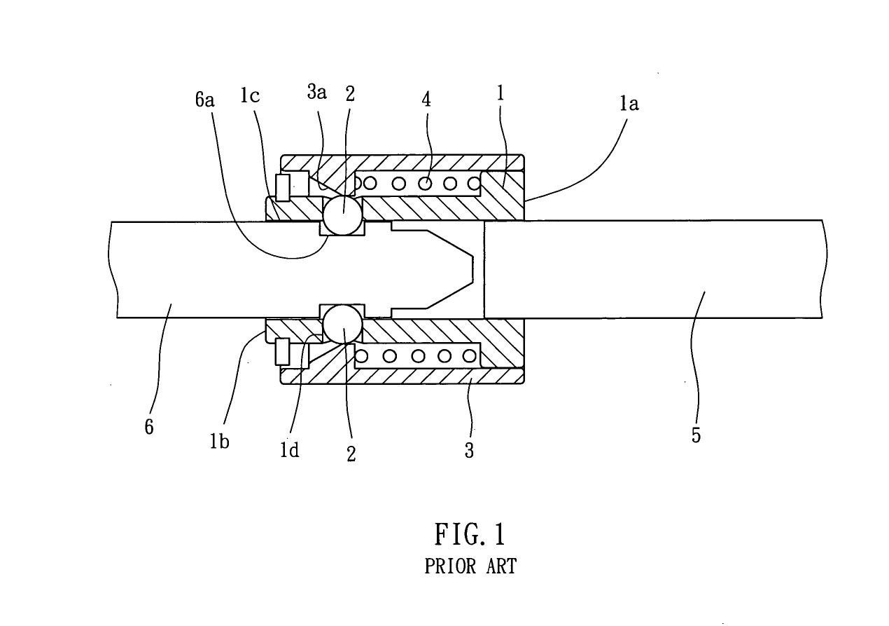

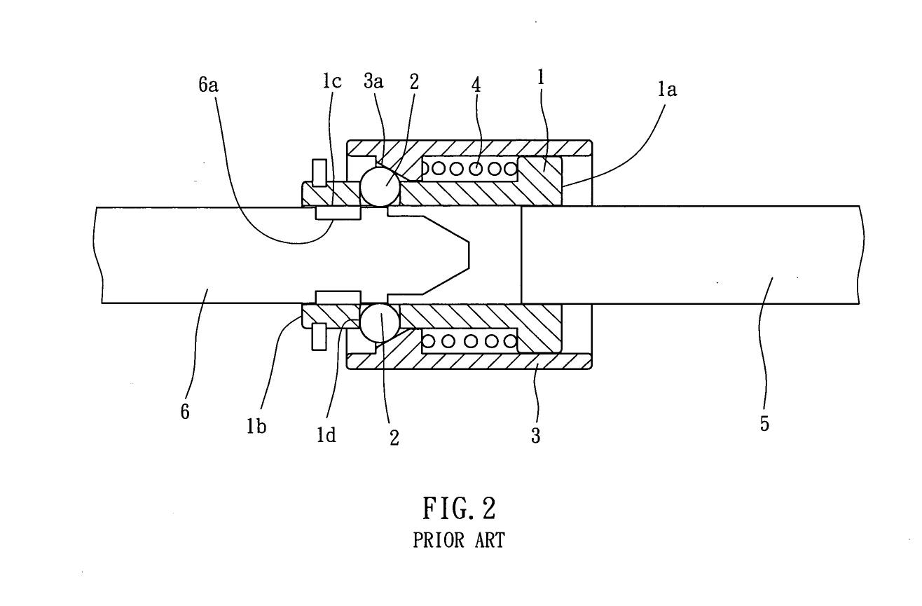

### DETAILED DESCRIPTION OF PREFERRED EMBODIMENTS

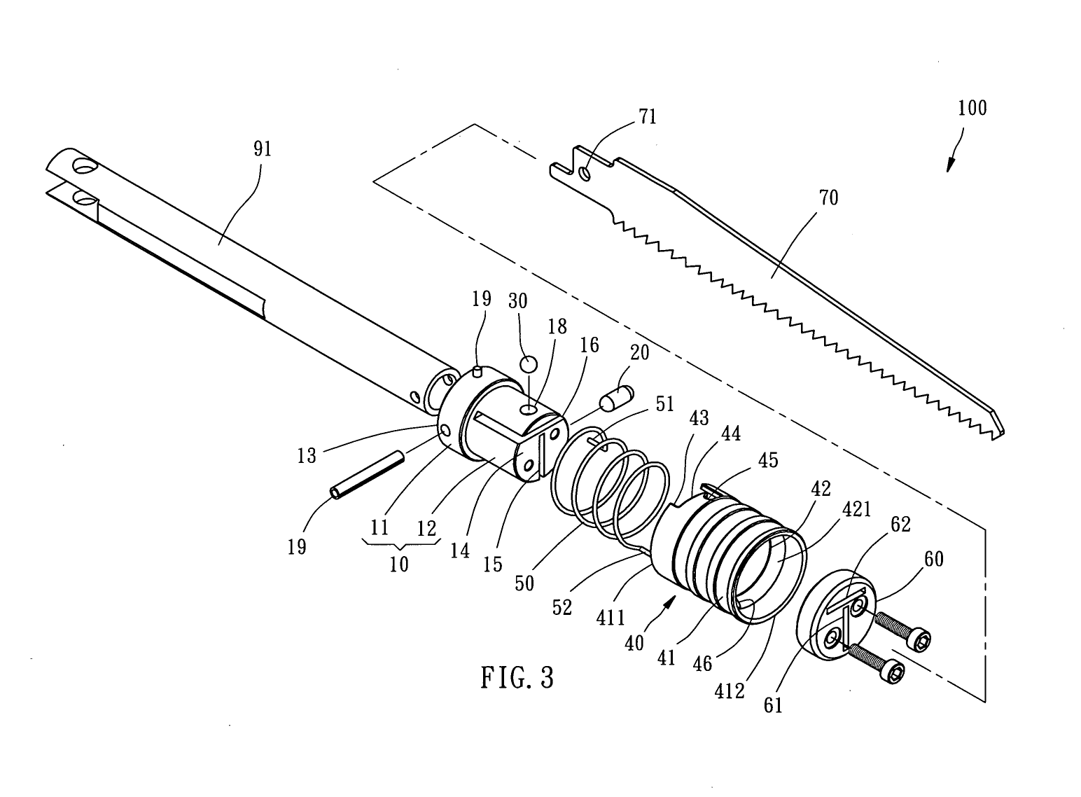

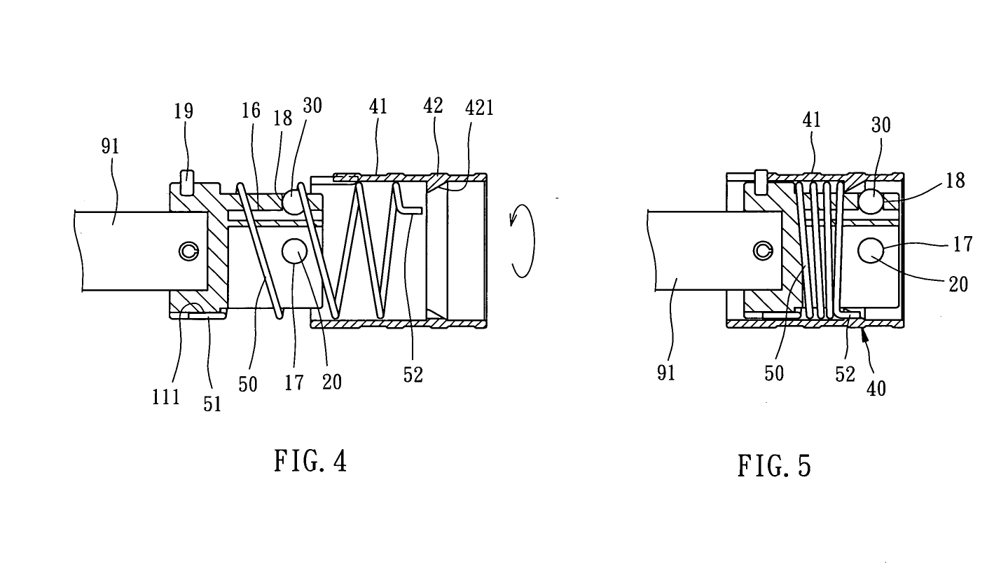

Referring to FIGS. 3-5, a saw gripping device 100 for a cutting machine, constructed according to a preferred embodiment of the present invention, is composed of a main body 10, two stoppers 20 and 30, a control member 40, a spring 50, and a retaining member 60.

The main body 10 is column-shaped, having a head portion 11 and a body portion 12, which are axially connected in one piece. The head portion 11 has a larger external diameter than the body portion 12 does. The head portion 11 defines a first end 12 located at a free end thereof. The body portion 12 defines a second end 14 located at a free end thereof opposite to the first end 13. The first end 13 is adapted for fixed connection with an output shaft 91 of the cutting machine. The body portion 12 is provided with a first receiving slot 15, a second receiving slot 16, a first through hole 17, and a second through hole 18. The first and second receiving slots 15 and 16 are parallel to an imaginary center axis of the main body 10 and are perpendicular to each other without communication with each other, each defining an opening at the second end 14. The first and second through holes 17 and 18 run through the first and second receiving slots 15 and 16 and an external periphery of the body portion 12 to form openings at the external periphery of the body portion 12 and sidewalls of the first and second receiving slots 15 and 16 respectively. The head portion 11 has a lug 19 formed at a predetermined position of an external periphery thereof, and a first positioning recess 111 formed at a predetermined position of the external periphery thereof.

The two stoppers 20 and 30 are inserted into the first and second through holes 17 and 18 respectively, having respective lengths, which are a little larger than respective depths of the first and second through holes 17 and 18, such that respective opposite parts of the two stoppers 20 and 30 are exposed outside the openings of the external periphery of the body portion 12 and the sidewalls of the first and second receiving slots 15 and 16.

The control member 40 includes a tube-shaped part 41 and a convex annular portion 42 located on an internal periphery of the tube-shaped part 41. The tube-shaped part 41 defines a first end 411 and a second end 412 located opposite to the first end 411. The convex annular portion 42 has an inclined annular convexity 421 extending slantwise from the internal periphery of the tube-shaped part 41 toward the first end 411. The tube-shaped part 41 has an extension part 43, a stopping portion 44, and a positioning portion 45. The extension part 43 extends axially for a predetermined distance from the first end 411 toward the second 412. The stopping portion 44 has a base end 441 and a distal end 442, wherein the base end 441 is connected with the extension part 43 at where is the closest to the second 412. The stopping portion 44 extends slantwise and axially along the tube-shaped part 41 from the base end 441 toward the distal end 442. The distance between the base end 441 and the second end 412 is larger than between the distal end 442 and the second end 412. The positioning portion 45 extends in the shape of arc from the distal end 442 toward the second end 412. The tube-shaped part 41 further has a second positioning recess 46 formed at a predetermined position of the internal periphery of the tube-shaped part 41. The control member 40 is sleeved onto the main body 10, allowing the stopping portion 44 to face the lug 19 and allowing the inclined annular convexity 421 to face the exposed parts of the stoppers 20 and 30 outside the openings of the external periphery of the main body 10.

The spring 50 is mounted between the control member 40 and the main body 10, having two free ends 51 and 52 fixedly inserted into the first and second positioning recess 111 and 46 respectively, for generating resilience acted as an axial impulse adapted for pushing the control member 40 to keep the control member 40 located at where the inclined annular convexity 421 contacts the stoppers 20 and 30, whereby the two free ends 51 and 52 are fixed to the main body 10 and the control member 40 respectively to further generate a torsion for torsion of the control member 40 and to keep the control member 40 located at where the stopping portion 44 lies against the lug 19.

The retaining member 60 is locked on the second end 14 of the main body 10. The retaining member 60 includes a larger external diameter than an internal diameter of the annular convex portion 42, such that the annular convex portion 42 can be confined between the retaining member 60 and the head portion 11 of the main body 10 to prevent the control member 40 from accidental disengagement from the main body 10. The retaining member 60 further includes a first through hole 61, which communicates with the first receiving slot 15, and a second through hole 62, which communicates with the second receiving slot 16.

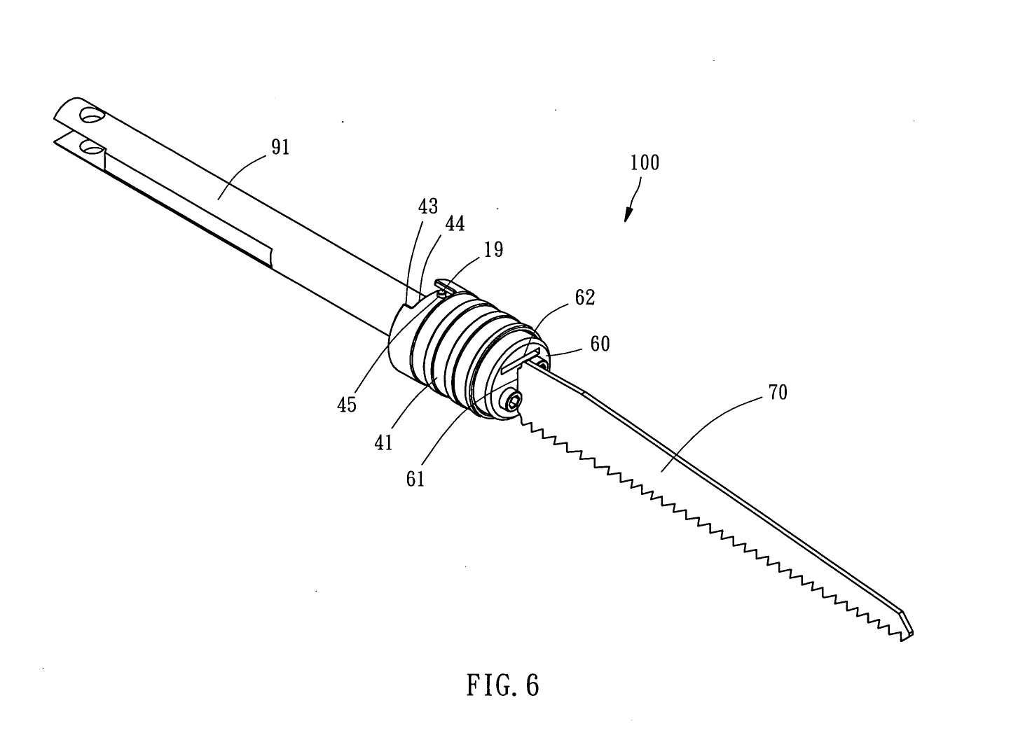

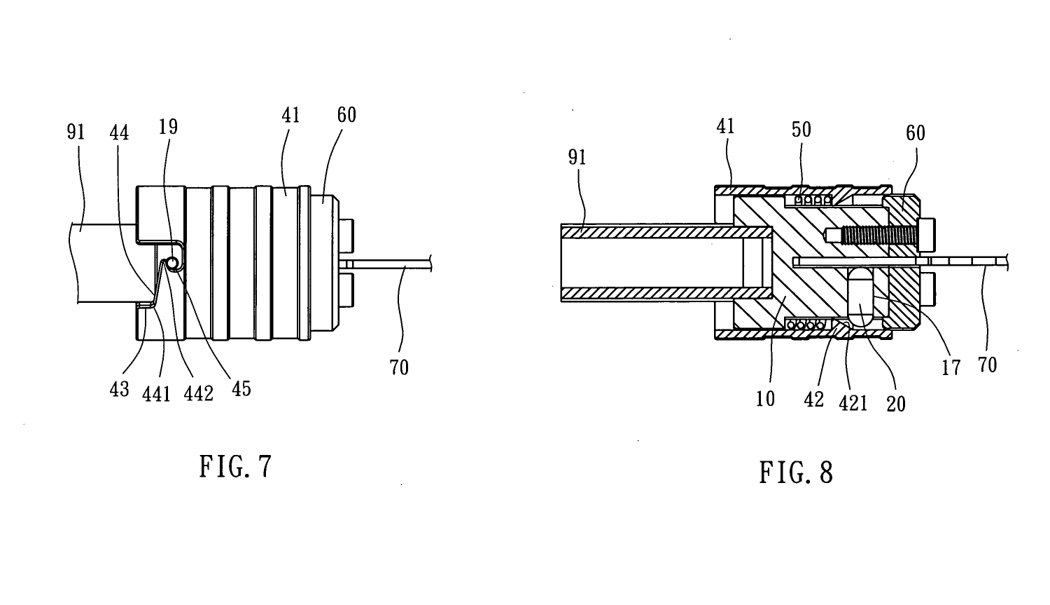

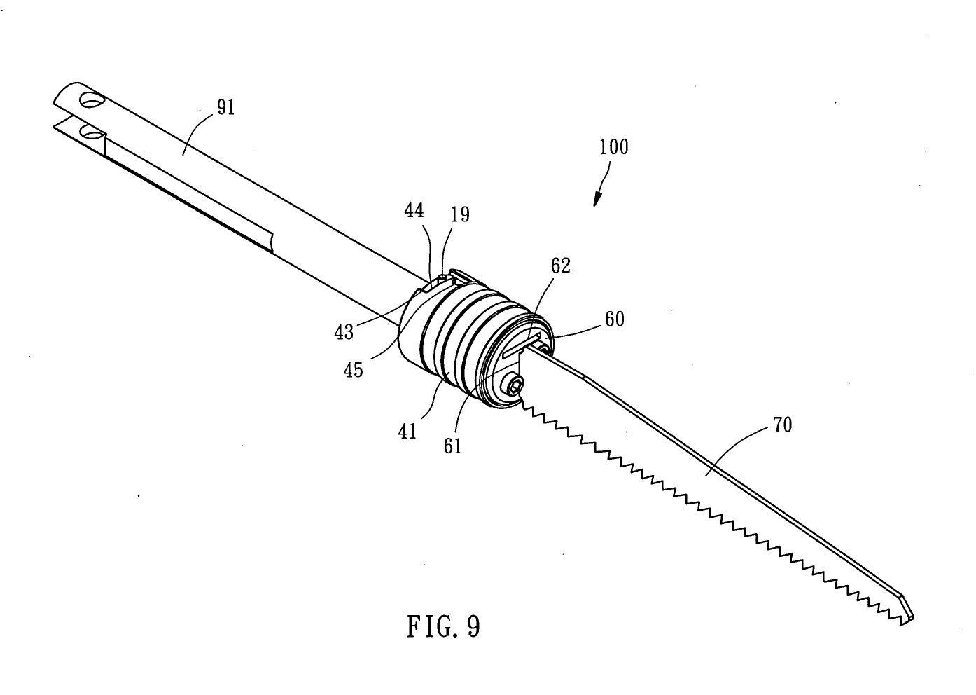

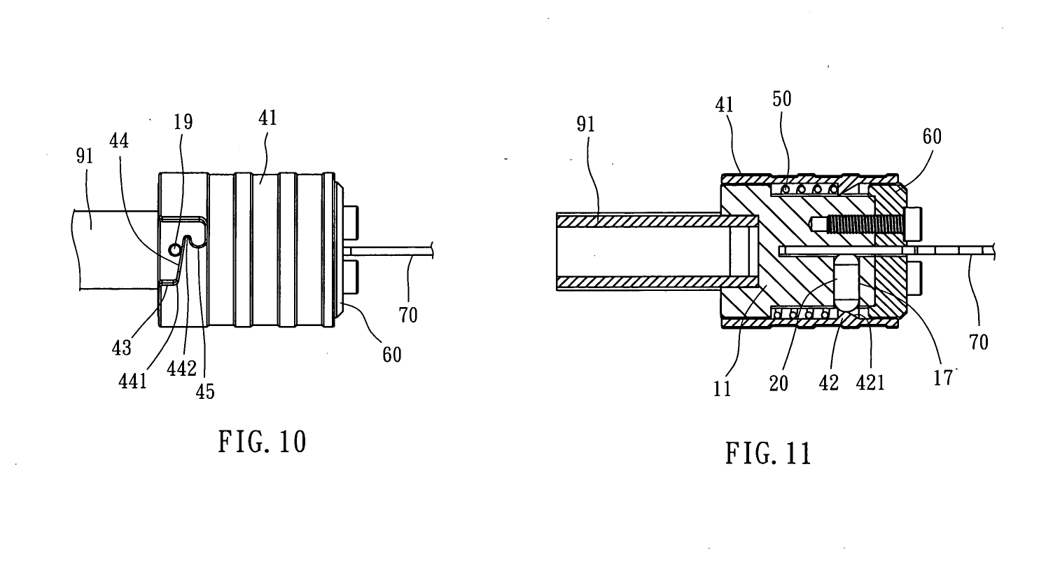

While intending to insert a cutting saw into the first receiving slot 15, a user can turn the control member 40 a little bit to counterwork the torsion of the spring 50 and to move the lug 19 from where it contacts against the stopping portion 43 to the positioning portion 45. Ad then, the user releases the control member 40 to allow the lug 19 to turn back by the torsion to tightly engage the positioning portion 45, as shown in FIGS. 6 and 7. In the meantime, the inclined annular convexity 421 does not contact against the stopper 20, as shown in FIG. 8, such that the cutting saw 70 can be inserted through the first through hole 61 into the first receiving slot 15. Next, the user turns the control member 40 a little bit to move the lug 19 from the positioning portion 45 to the stopping portion 44, as shown in FIGS. 9 and 10. Meanwhile, the torsion of the spring 50 is available such that the lug 19 can tightly contact against the stopping portion 44. When the lug 19 is moved to the stopping portion 44, the inclined annular convexity 421 lies against an end of the stopper 20 to drive the stopper 20 in the first through hole 17 to move toward an imaginary center axis of the main body 10, and the other end of the stopper 20 lies against a gripping hole 71 of the cutting saw 70, as shown in FIG. 11. Therefore, the operation of gripping the cutting saw 70 is accomplished.

In such a way that the stopping portion 44 lies against the lug 19 by means of the torsion of the spring 50, the control member 40 can be avoided from incorrect action incurred by an inertial force generated during rapid reciprocating motion of the cutting machine 100 or by impact of an unexpected object, and the cutting saw 70 can be further avoided from accidental disengagement.

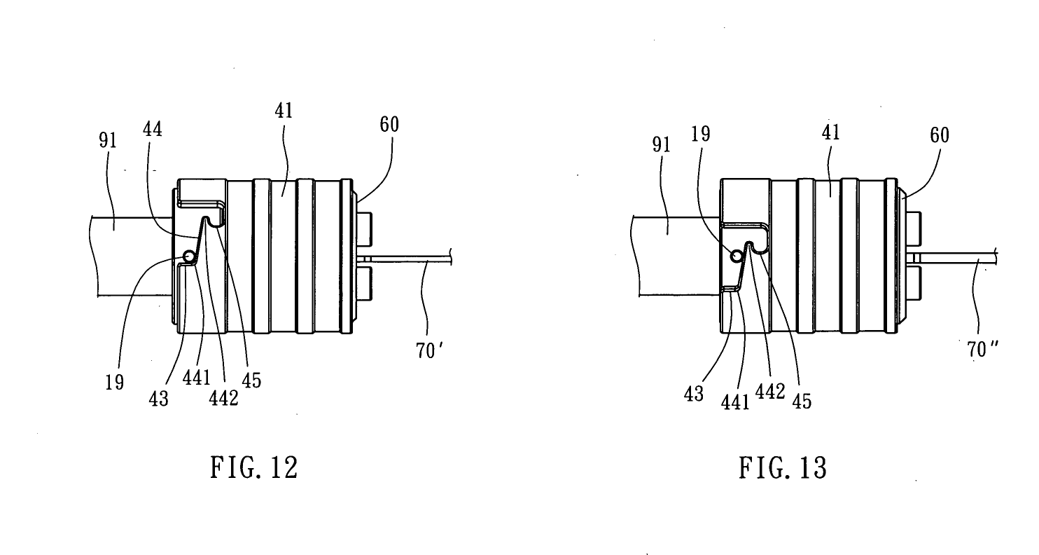

In addition, the saw gripping device 100 of the present invention can grip cutting saws having different thicknesses. Referring to FIG. 12, while the saw gripping device 100 holds a thinner cutting saw 70′ according to the same steps as mentioned above, the lug 19 can lie against the stopping portion 44 at where is close to the base end 441, and the control member 40 is still forced by the torsion of the spring 50 to enable the lug 19 to tightly lie against the stopping portion 44 to firmly hold the cutting saw 70. Referring to FIG. 13, while the saw gripping device 100 holds a thicker cutting saw 70″ according to the same steps as mentioned above, the lug 19 can lie against the stopping portion 44 at where is close to the distal end 442, and the control member 40 is still forced by the torsion of the spring 50 to enable the lug 19 to tightly lie against the stopping portion 44 to firmly hold the cutting saw 70″. In light of this, the saw gripping device 100 of the present invention can hold the cutting saws of different thicknesses, having variable applicability, and can prevent the control member from incorrect action.

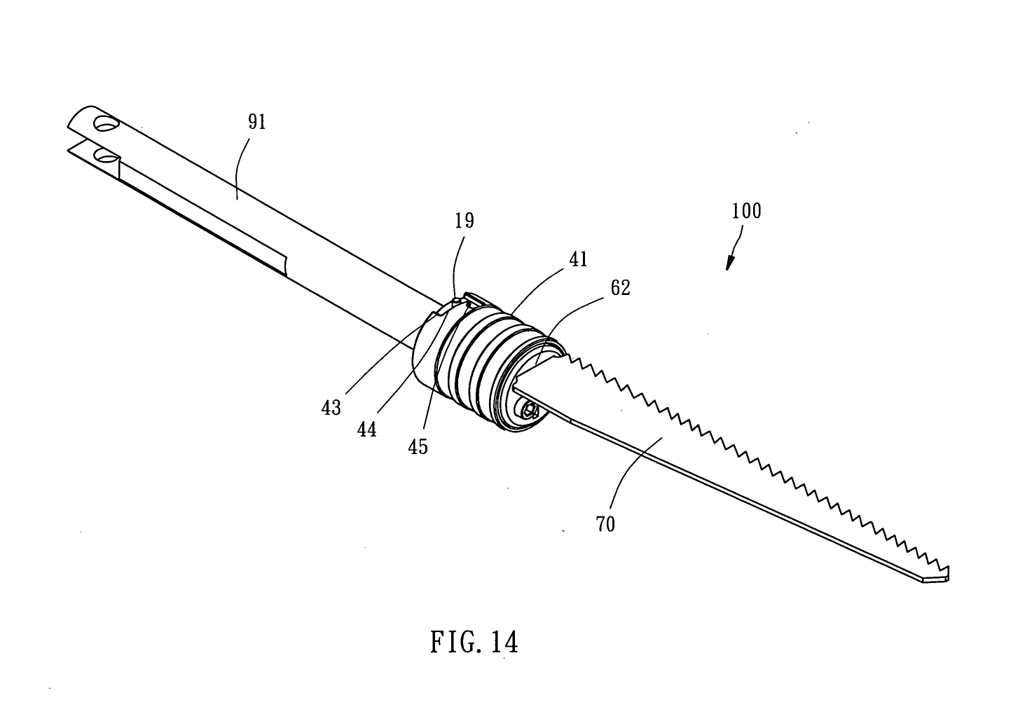

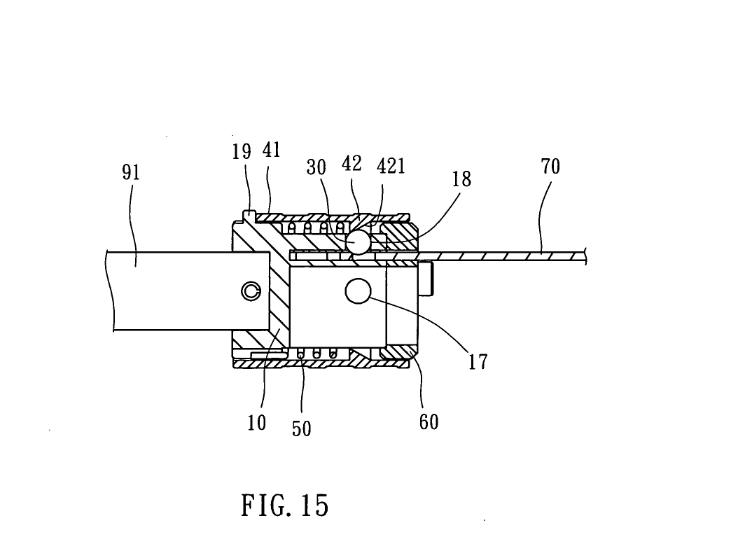

Further, referring to FIGS. 14 and 15, while the user intends to proceed to cutting along a different direction, the user can insert the cutting saw 70 through the second through hole 62 into the second receiving slot 16 by the same steps as mentioned above, and then the stopper 30 in the second through hole 18 holds the cutting saw 70. Therefore, the present invention enables the cutting manner to become more diverse and facilitates the operational convenience for the user.

Although the present invention has been described with respect to a specific preferred embodiment thereof, it is no way limited to the details of the illustrated structures but changes and modifications may be made within the scope of the appended claims.

What is claimed is:

1. A saw gripping device for a cutting machine, comprising:
a column-shaped main body having a first end and a second end opposite to said first end, said first end being adapted for connection with an output shaft of said cutting machine, said main body further having at least one receiving slot and at least one through hole, said at least one receiving slot being parallel to an imaginary center axis of said main body, said at least one receiving slot forming an opening at an end surface of said second end, said at least one through hole forming an opening at each of an external periphery of said main body and a sidewall of said at least one receiving slot, a lug being formed at a predetermined position of the external periphery of said main body;
at least one stopper inserted into said at least one through hole and having two opposite parts exposed outside said at least one through hole and the opening of said at least receiving slot;
a control member having a tube-shaped part and a convex annular portion formed on an internal periphery of said tube-shaped part, said tube-shaped part having a first end and a second end, said convex annular portion having an inclined annular convexity extending slantwise from the internal periphery of said tube-shaped part toward said first end of said tube-shaped part, said tube-shaped part having a stopping portion having a base end and a distal end, a distance between said second end of said tube-shaped part and said base end being larger than between said second end of said tube-shaped part and said distal end, said stopping portion extending slantwise from said base end with respect to an imaginary center axis of said main tube-shaped part toward said distal end, said control member being sleeved onto said main body, said stopping portion facing said lug, said inclined annular convexity facing the exposed parts of said at least one stopper is exposed outside the opening of the external periphery of said main body; and
a spring mounted between said control member and said main body and having two ends fixed to said control member and said control member respectively, resilience of said spring generating axial impulse and torsion for pushing said control member and keeping said control member located at where said inclined annular convexity contacts said at least one stopper and where said stopping portion lies against said lug.

2. The saw gripping device as defined in claim 1 comprising two stoppers; said main body having two receiving slots and two through holes, said two receiving slots being perpendicular to each other and not in communication with each other, said stoppers being mounted in said through holes respectively.

3. The saw gripping device as defined in claim 1, wherein said main body comprises a first positioning recess formed at a predetermined position of the external periphery thereof; said tube-shaped part comprises a second positioning recess formed at the internal periphery thereof; the two ends of said spring are fixedly inserted into said first and second positioning recesses respectively.

4. The saw gripping device as defined in claim 1, wherein said tube-shaped part further comprises an extension part extending for a predetermined distance from the first end thereof toward the second thereof; said base end of said stopping portion is connected with said extension part at where is close to the second end of said tube-shaped part.

5. The saw gripping device as defined in claim 1, wherein said tube-shaped part further comprises a positioning portion extending in the shape of arc from a distal end of said stopping portion toward the second end of said tube-shaped part; while said control member is forced to counterwork the torsion of said spring to move said lug into said positioning portion, said inclined annular convexity does not contact said at least one stopper.

6. The saw gripping device as defined in claim 1 further comprising a retaining member, said retaining member being fixed to the second end of said main body and having at least one lot in communication with said at least one receiving slot for avoiding disengagement of said control member from said main body.

7. The saw gripping device as defined in claim 6, wherein an external diameter of said retaining member is larger than an internal diameter of said convex annular portion to confine said convex annular portion between said retaining member and said main body for avoiding disengagement of said control member from said main body.
